(19) United States
(12) Patent Application Publication
(10) Pub. No.: US 2020/0307707 A1
(43) Pub. Date: Oct. 1, 2020

(54) EXTRUSION WITH INTEGRATED CONNECTOR

(71) Applicant: Zephyros, Inc., Romeo, MI (US)

(72) Inventor: Kenneth S. Makuch, Swartz Creek, MI (US)

(21) Appl. No.: 16/814,017

(22) Filed: Mar. 10, 2020

Related U.S. Application Data
(60) Provisional application No. 62/823,139, filed on Mar. 25, 2019.

(51) Int. Cl. B62D 25/04; B62D 27/02; F16B 11/00

(52) U.S. Cl. CPC B62D 25/04; F16B 11/006; B62D 27/026

(57) ABSTRACT

A structural assembly comprising: a plurality of members connected via one or more connectors, wherein the one or more connectors are integrally formed with the plurality of members and the plurality of members are connected via the one or more connectors during extrusion of the plurality of members.

### FIELD

The present teachings generally relate to structural members, and more specifically, to structural co-members connected by one or more integrated connectors.

### BACKGROUND

For many years, various industries have been concerned with designing and providing structural materials to improve structural characteristics of articles such as: adhesion; baffling, sealing; noise and/or vibration dampening; strength reinforcement; other structural characteristics; or a combination thereof. An exemplary industry requiring ongoing improvements to structural materials is the automotive industry and articles of manufacture for automotive vehicles. It has become increasingly important to provide reinforcing materials that are light-weight, cost-effective, and easy to assemble to maintain cost of vehicles while increasing structural integrity.

To meet the above demands, attempts have been made to create structural reinforcements having tunability to meet the shape of various structural cavities. These structural reinforcements are often times created using manufacturing methods that attempt to optimize cost and manufacturing time, such as extrusion, pultrusion, injection-molding, or a combination thereof. However, challenges often arise during such manufacturing processes when attempting to create structural reinforcements for comparatively larger structures, cavities, or both. Often times, manufacturing processes such as extrusion, pultrusion, injection-molding, or a combination thereof require that a shape of the structural reinforcement be made with maximum dimensions based on the limitations of the manufacturing tool. As a result, multiple structures may be frequently assembly or secured together after manufacturing to create an overall assembly that matches the desired shape of a given application. However, by assembling multiple structures together, the process drastically increases in time and cost, resulting in a significantly less cost-effective assembly. Additionally, often times these structures may have a secondary material disposed on one or more surfaces after assembly. As a result, the structures must first be formed, connected via a secondary operation, and then include a final operation of disposing the secondary material on the assembly.

Examples of structural assemblies having a secondary material are disclosed in U.S. Pat. Nos. 7,144,071; 7,255,388; 7,790,280; 8,741,094; 8,808,478; 8,967,327; and 9,427,902; U.S. Publication Nos. 2005/0212332; 2005/0230027; 2014/0292029; and 2018/0050474; and PCT Publication Nos. WO2012/062448; WO2012/143305; and WO2018/025076, all of which are incorporated by reference herein for all purposes. It would be attractive to have an alternative reinforcement structure that provides a desired shape for a given application. What is needed is a structural reinforcement that provides a desired shape beyond the limitations of a manufacturing process. It would be attractive to have a reinforcement structure the optimizes the manufacturing time and cost. What is needed a structural reinforcement that connects a plurality of structures together during a single process, free of secondary operations.

### SUMMARY

The present teachings meet one or more of the present needs by providing a structural assembly comprising: a plurality of members connected via one or more connectors, wherein the one or more connectors are integrally formed with the plurality of members and the plurality of members are connected via the one or more connectors during extrusion of the plurality of members.

The present teachings meet one or more of the present needs by providing a method of forming a structural assembly according to any of the preceding claims comprising co-extruding a plurality of members, wherein the plurality of members are connected via one or more integrally formed connectors, and the connection occurs during the co-extrusion process.

The present teachings meet one or more of the present needs by providing a structural assembly, wherein: the plurality of members are co-extruded; a first member includes a receiving portion and a second member includes an engaging portion, and the receiving portion receives the engaging portion during extrusion to form the connector; a surface of each of the plurality of members is coplanar, and the one or more connectors project from the surface of the each of the plurality of members; an exterior surface of each of the plurality of members is coplanar, and the one or more connectors are recessed or extend substantially perpendicular to the exterior surface of each of the plurality of members; the plurality of members include one or more ribs; the structural assembly has a length greater than 200 mm; the plurality of members include an adhesive material disposed on one or more surfaces; the connector includes an adhesive material disposed on one or more surfaces; the connector is a dovetail joint; the connector includes an engaging portion having one or more fingers that are received by a receiving portion having one or more channels; the adhesive material is an expandable material; the one or more fingers are a plurality of fingers that are each received by a separate channel; the one or more ribs are a plurality of ribs, and the one or more ribs have a non-uniform height and are configured to compress during an impact; the one or more connectors are only disconnected after extrusion via inelastic deformation; each of the plurality of members includes a receiving portion, an engaging portion, or both; the plurality of members are substantially equal in length; the receiving portion encloses the engaging portion; the one or more ribs elastically deform during activation of an expandable adhesive material disposed on the plurality of members, and the one or more ribs include one or more bends to deflect the expandable adhesive material in a desired direction; the structural assembly is shaped substantially the same as a cavity of a structure so that the structural assembly reinforces the structure after being inserted into the cavity; or a combination thereof.

The present teachings meet one or more of the present needs by providing: an alternative reinforcement structure that provides a desired shape for a given application; a structural reinforcement that provides a desired shape beyond the limitations of a manufacturing process; a reinforcement structure the optimizes the manufacturing time and cost; a structural reinforcement that connects a plurality of structures together during a single process, free of secondary operations; or a combination thereof.

### BRIEF DESCRIPTION OF THE DRAWINGS

FIG. 1A illustrates a structural assembly having an integrated connector;

FIG. 1B illustrates a structural assembly having an integrated connector;

FIG. 2A illustrates a structural assembly having an integrated connector;

FIG. 2B illustrates a structural assembly having an integrated connector and an adhesive material; and

FIG. 3 illustrates a structural assembly having a plurality of ribs and an adhesive material.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein relate to a structural assembly. The structural assembly may function to reinforce one or more articles of manufacture. The one or more articles of manufacture may be configured for one or more industries, such as commercial and/or residential construction, automotive, aeronautical, nautical, transportation, consumer product, or a combination thereof. For example, the structural assembly may be configured to reinforce an automotive vehicle, a component of an automotive vehicle, or both. The structural assembly may reinforce a cavity, hollow member, panel, other structure, or a combination thereof. The structural assembly may reinforce by improving one or more structural characteristics of an article. The one or more structural characteristics may be strength, stiffness, vibration dampening, sealing, noise absorption, thermal insulation, baffling, or a combination thereof. The structural assembly may include one or more structurally rigid portions, one or more flexible portions, one or more adhesive portions, one or more mechanically interlocking portions, or a combination thereof. For example, the structural assembly may include a structurally rigid member having an expandable adhesive material disposed on the member. The structural assembly may be configured for insertion into a location on or in an article for localized reinforcement. For example, the structural assembly may be inserted into a cavity of one or more pillars of an automotive body (i.e., A-pillar, B-pillar, C-pillar, etc.) and positioned so that, when activated, an adhesive material of the structural assembly expands and substantially fills a portion of the cavity to locally reinforce the one or more pillars. Alternatively, the adhesive material may be free of expansion and adhere the structural assembly to the one or more pillars in a desired location requiring reinforcement. The desired location may be any portion of an article that may require reinforcement. For example, an article may be modeled using computer-aided engineering (CAE) software and a finite element analysis (FEA) may be generated to illustrate structural weak points of the article requiring reinforcement.

The structural assembly may be any size and shape desired for an application. The structural assembly may vary in thickness, width, length, height, or a combination thereof. The structural assembly may include one or more arcuate portions, one or more contoured portions, one or more undulating portions, one or more cavities, one or more holes, one or more curved portions, one or more edges, one or more projections, one or more recesses, or a combination thereof. The structural assembly may have a substantially uniform size and shape or may have a varying size and shape. For example, the structural assembly may vary in size and shape between different segments of the structural assembly. The structural assembly may be substantially shaped to mate with an article being reinforced by the structural assembly. For example, the structural assembly may be substantially “C” shaped to be inserted into a substantially “C” shaped channel of a pillar of an automotive vehicle. The structural assembly may be substantially “A” shaped, “C” shaped, “D” shaped, “P” shaped, “G” shaped, “V” shaped, “L” shaped, “U” shaped, or a combination thereof. The structural assembly may have one or more arms, one or more fingers, one or more bends, one or more flanges, or a combination thereof.

The structural assembly may include a member. The member may function to support an adhesive material of the structural assembly. The member may function to reinforce an article of manufacture. The member may function as a substrate for the adhesive material of the structural assembly. The member may be structurally rigid. The member may be flexible. The member may be shaped similar to an adhesive material so that the adhesive material is disposed on a surface of the member. The member may mechanically secure the adhesive material to the member free of secondary fasteners, secondary adhesives, or both. The member may include one or more abrasive surfaces to increase friction between the adhesive material and the member. The member may include one or more holes, one or more cavities, or both. The member may be substantially planar or may include one or more contoured surfaces. The member may be injection molded, stamped, cast, extruded, pultruded, cut, or a combination thereof.

The member may have a desired thickness. The member may have a thickness of about 1 mm or more, about 5 mm or more, about 10 mm or more, or about 20 mm or more. The member may have a thickness of about 50 mm or less, about 40 mm or less, or about 30 mm or less. The member may maintain a substantially uniform thickness or may have segmented portions having varying thicknesses. For example, the member may have a first segment having a thickness of about 20 mm and a second segment having a thickness of about 10 mm. A thickness of the member may be configured to meet one or more mechanical characteristics. For example, the thickness of the member may directly correlate to a load capacity of the structural member. As such, an increase in thickness of the structural member may result in an increased load capacity, or vice versa. The member may have a desired length. A length of the member may be about 50 mm or more, about 100 mm or more, or about 150 mm or more. The length of the member may be about 300 mm or less, about 250 mm or less, or about 200 mm or less. The dimensions of each member may be uniform or members may vary in length, thickness, width, or a combination thereof.

An overall length of the structural assembly may be greater than a length of the individual members. For example, a plurality of members may be longitudinally interconnected so that a length of the structural assembly is substantially equal to a total sum of the lengths of each of the plurality of members. Alternatively, the structural assembly may have a length less than a length of the individual members. For example, the plurality of members may be latitudinally interconnected so that a length of a single member is greater than a length of the plurality of member connected in a width direction.

The member may be formed from a polymer, metal, fibrous material, or a combination thereof. The member may include one or more layers disposed on each other to form a monolithic member. For example, the member may include a metal layer disposed on a polyamide layer. The member may be shaped to mate with a shape of one or more adhesive materials. The member be configured to secure the structural assembly to an article of manufacture being reinforced. For example, the member may include one or more attachment portions that connect the member to the article of manufacture. Alternatively, the member may be free of connecting portions and the member is connected to the article of manufacture via a friction-fit, interference-fit, or both.

The structural assembly may include a single member or may include a plurality of members. For example, the structural assembly may include an adhesive material sandwiched between opposing members. Alternatively, the structural assembly may include a plurality of members secured to one another via one or more connectors or connecting portions.

The member may be pre-treated prior to connection to the adhesive material or additional members. The member may be pre-treated using any surface treatments or treatment processes, such as degreasing, anodizing, galvanizing, phosphatizing, enameling, blackening, electroplating, chrome plating, nickel plating, plasma coating, sand blasting, cleaning, lapping, painting, or a combination thereof. The pre-treatment may be utilized to improve connection between the member and the adhesive material, one or more additional members, one or more secondary components, the article being reinforced, or a combination thereof.

The member may include a bend. The bend may function to provide a contour of the member that corresponds to a contour of an article being reinforced. The bend may function to improve structural integrity. The bend may vary in size and shape. The bend may connect portions of the member. For example, the bend may connect a pair of substantially planar portions of the member and the planar portions may be substantially parallel to one another. The bend may extend from portions of the member at any angle. The bend may extend from portions of the member at an angle of about 30 degrees or more, about 45 degrees or more, about 60 degrees or more, or about 75 degrees or more. The bend may extend from portions of the member at an angle of about 135 degrees or less, about 120 degrees or less, about 105 degrees or less, or about 90 degrees or less.

The bend may be monolithic (e.g., integrally formed) with the member. The bend may be any contour, curl, flange, chamfer, or a combination thereof. The member may include a plurality of bends. The member may include two or more bends, three or more bends, or four or more bends. The member may include seven or less bends, six or less bends, or five or less bends. The bends may be structurally rigid or may be flexible.

The member may include one or more ribs. The one or more ribs may function to provide structural support to the member. The one or more ribs may be integrally formed with the member. For example, the member may be extruded in a desired shape having a plurality of ribs. The ribs may extend along a longitudinal axis of the member, a latitudinal axis of the member, or both. For example, the ribs may extend along the member coaxial to the longitudinal axis, parallel to the longitudinal axis, or both. The ribs may project from a surface of the member. For example, the ribs may project substantially orthogonal to a base surface of the member. The ribs may project from a surface at any desired angle. The ribs may project relative to a surface of the member at an angle of about 30 degrees or more, about 45 degrees or more, or about 60 degrees or more. The ribs may project relative to a surface of the member at an angle of about 120 degrees or less, about 105 degrees or less, or about 90 degrees or less.

The ribs may have a thickness substantially equal to an overall thickness of the member. The ribs may have an increased thickness relative to the member, a decreased thickness relative to the member, or both. For example, a first set of ribs may have a thickness greater than the thickness of the member and a second set of ribs may have a thickness less than the thickness of the member. The ribs may be locally reinforced with one or more reinforcing additives during the extrusion process, after the extrusion process, or both. For example, the ribs may be locally reinforced with glass to increase structural integrity of the ribs. The ribs may have a uniform height or varying heights. The height of the ribs may be about 10 mm or more, about 20 mm or more, or about 30 mm or more. The height of the ribs may be about 60 mm or less, about 50 mm or less, or about 40 mm or less.

A plurality of members may be connected via a connector. The connector may function to connect a plurality of members to one another to form the structural assembly. The connector may be integrally formed with one or more members. The connector may have a first portion that is part of a first member and a second portion that is part of a second member. For example, the first member may include a receiving portion that receives an engaging portion of a second member. The receiving portion and the engaging portion may form the connector.

The connector may project from one or more surfaces of the member. The connector may recess from one or more surfaces of the member. The connector may be any size and shape required to connect two or more members together. The connector may connect two or more members, three or more members, or four or more members. The connector may connect seven or less members, six or less members, or five or less members. The connector may include one or more engaging features, one or more receiving features, or a combination thereof. The connector may be any mechanical connector that may secure the members to one another. The connector may include a hook, latch, finger, tooth, fastener, protrusion, projection, extension, key, button, clasp, or a combination thereof. The hook, latch, finger, tooth, fastener, protrusion, projection, extension, key, button, clasp, or a combination thereof may be received by a slot, hole, recess, channel, clamp, keyhole, jaw, finger, or a combination thereof. The connector may be a dovetail connection, a hook and loop connection, a biscuit joint, a mortise and tenon joint, a tongue and groove joint, or a combination thereof.

The connector may be flexible. The connector may be structurally rigid. The connector may include one or more adhesives. The connector may be free of adhesives. The connector may include one or more friction modifiers to aid in connection. The one or more friction modifiers may be grease, oil, silicone, another lubricant, or a combination thereof. The connector may secure a plurality of members together so that the connection may not be disconnected without inelastically deforming the connector, damaging the connector, or both so that the plurality of members may not be reconnected. Alternatively, the connectors may be removably attachable and configured to be connected and disconnected one or more times.

The connector may include a receiving portion. The receiving portion may function to receive an engaging portion of the connector to secure the plurality of members together. The receiving portion may be integrally formed with one or more members. The receiving portion may include one or more slots, holes, recesses, channels, clamps, keyholes, jaws, fingers, or a combination thereof. The receiving portion may be recessed from a surface of the member. The receiving portion may be shaped substantially similar to an engaging portion so that, upon receiving the engaging portion, the engaging portion substantially fills a shape of the receiving portion.

The receiving portion may be a plurality of receiving portions. For example, the receiving portion may include a plurality of slots that each receive an engaging portion. A single receiving portion may receive a plurality of engaging portions. For example, a single channel may receive a plurality of fingers. The receiving portion may project from one or more surfaces of the member. The receiving portion may fully enclose an engaging portion of the connector after connection. The enclosure may prevent debris, moisture, or both from entering the receiving portion and damaging the receiving portion, the engaging portion, or both. The receiving portion may include one or more adhesive materials on one or more surfaces. The one or more surfaces may be an exterior surface, an interior surface, or both.

The receiving portion may include one or more hinges, one or more joints, or both. The receiving portion may include one or more projections, one or more extensions, one or more contours, one or more curves, one or more arcuate portions, one or more channels, one or more undulations, one or more curves, one or more bends, one or more flanges, one or more bumps, one or more planar portions, or a combination thereof. The receiving portion may include one or more fingers, one or more hooks, one or more clasps, or a combination thereof. The receiving portion may be structurally reinforced to prevent breaking of the receiving portion during connection.

The connector may include an engaging portion. The engaging portion may function to connect a plurality of members by securing the engaging portion in a receiving portion of the connector. The engaging portion may be configured to mate with the receiving portion. The engaging portion may be a hook, latch, finger, tooth, fastener, protrusion, projection, extension, key, button, clasp, or a combination thereof. The engaging portion may engage the receiving portion during manufacturing, after manufacturing (e.g., during a secondary assembly operation), or both. The engaging portion may include one or more hinges, one or more joints, or both. The engaging portion may include one or more projections, one or more extensions, one or more contours, one or more curves, one or more arcuate portions, one or more channels, one or more undulations, one or more curves, one or more bends, one or more flanges, one or more bumps, one or more planar portions, or a combination thereof. The engaging portion may include an adhesive material disposed on one or more surfaces to secure the engaging portion to the receiving portion, another component, an article being reinforced, or a combination thereof.

The engaging portion may be substantially contained within the receiving portion after connection. A portion of the engaging portion may be contained within the receiving portion after connection. For example, about 30% or more, about 40% or more, or about 50% or more of the engaging portion may be contained within the receiving portion. About 100% or less, about 90% or less, or about 80% or less of the engaging portion may be contained within the receiving portion. The engaging portion may be contained within the receiving portion so that debris, moisture, or both do not contact the engaging portion, thereby resulting in degradation or damage of the connector. The engaging portion may be shaped substantially similar to the receiving portion so that the engaging portion is substantially flush with an interior shape of the receiving portion. The engaging portion may extend through an aperture of the receiving portion. For example, the engaging portion may be a threaded fastener that threads into and extends through the receiving portion.

The engaging portion may be flexible to allow elastic movement of the engaging portion during connection of the connector. The engaging portion may be structurally rigid so that, if attempts are made to disconnect the connector, the engaging portion will inelastically deform, fracture, or both. The engaging portion may be any shape to mate with the receiving portion. The engaging portion may be “T” shaped, “L” shaped, “V” shaped, “C” shaped, “D” shaped, “S” shaped, or a combination thereof. The engaging portion may substantially mirror a shape of the receiving portion.

An adhesive material may be disposed on one or more surfaces of the structural assembly. The adhesive material may be configured to adhere the structural assembly to an article being reinforced, additional structural assemblies, or both. The adhesive material may function to baffle noise of the reinforcing member, the article being reinforced, or both. The adhesive material may be shaped substantially similar to the member so that the adhesive material substantially covers one or more surfaces of the member. The adhesive material may be disposed on a portion of the member. The adhesive material may include one or more connecting features to secure the adhesive material to the member, the member may include one or more connecting features to secure the adhesive material to the member, or both. The one or more connecting features may be a hook, latch, pin, column, flange, lip, fin, projection, hole, cavity, recess, or a combination thereof.

The adhesive material may be any adhesive material that forms a bond between the structural assembly and the member, an article being reinforced, or both. The adhesive material may be heat activatable, activated by an activating agent, or both. The adhesive material may be expandable upon activation. The adhesive material may be dry to the touch, non-tacky, or both prior to activation. The adhesive material may be room stable. The adhesive material may include an adhesive polymeric material (e.g., epoxy resin or the like). The adhesive material may include one or more of the following: an epoxy resin; a flexibilizer; a phenoxy resin; an impact modifier; a blowing agent; a curing agent; a filler; or a combination thereof. If the adhesive material is expandable or foamable, the adhesive material may expand to a volume greater than its volume in the unexpanded state (e.g., at least 5% greater, at least 20% greater, or even possibly at least 50% greater). The volumetric expansion may be about 400% or less, about 300% or less, or about 200% or less relative to the original unexpanded volume. The volumetric expansion may be about 50% or more, about 100% or more, or about 150% or more relative to the original unexpanded volume. Alternatively, the volume of the adhesive material may be less after activation due to curing (e.g., cross-linking) for foamed and/or unfoamed versions of the adhesive material. A plurality of adhesive materials may be disposed on one or more surfaces the structural assembly. Examples of adhesive materials may be found in U.S. Pat. Nos. 6,846,559; 6,923,499; 7,125,461; 7,199,165; 7,521,093; 7,892,396; 8,236,128; 8,334,055; 8,475,694; and 8,702,889, all of which are incorporated by reference herein for all purposes.

The structural assembly may be manufactured using a variety of methods. The structural assembly may be formed using an extrusion process, a pultrusion process, an injection-molding process, or a combination thereof. The structural assembly may be simultaneously formed and assembled during a single process. For example, a plurality of members of the structural assembly may be co-extruded (i.e., extruded adjacent to one another simultaneously) and one or more connectors connecting the plurality of members may be extruded and connected with the extrusion of the plurality of members. By connecting the plurality of members during an extrusion process, the manufacturing of the structural assembly is free of a secondary operation required for connecting the members. The extrusion process may be completed using one or more extrusion dies.

Extruders may frequently have limitations that prevent desired shapes from being extruded. For example, the extruder may only extrude an extrudate having a length of about 100 mm or more, about 125 mm or more, or about 150 mm or more. The extruder may only extrude an extrudate having a length of about 225 mm or less, about 200 mm or less, or about 175 mm or less. However, because the connector may be integrally formed with the members of the structural assembly and the members may be connected during the extrusion process, the structural assembly may be manufactured having an overall length greater than the maximum dimensions limited by the extruder capabilities. The length may correspond to a width of a material being extruded through the extruder (i.e., a dimension substantially perpendicular to a direction of extrusion), a length of a material being extruded through the extruder (i.e., a dimension substantially parallel to a direction of extrusion), or both.

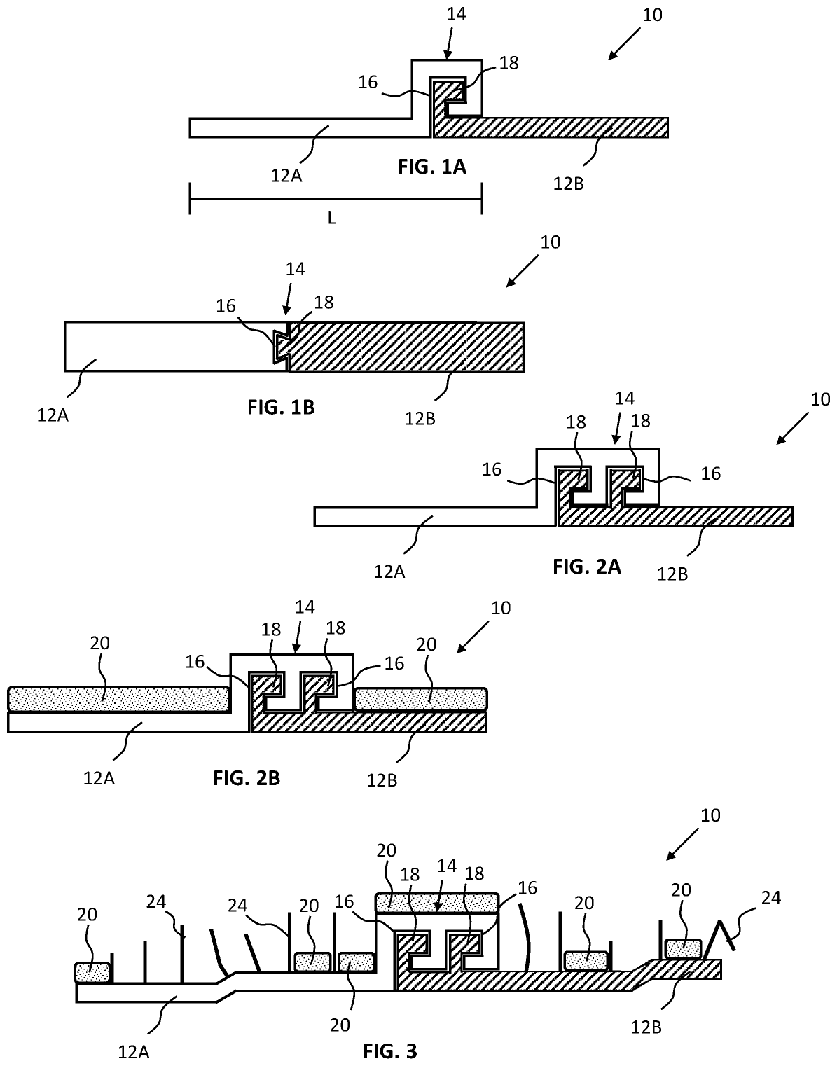

Turning now to the figures, FIGS. 1A and 1B illustrate structural assemblies 10. The structural assembly 10 includes a plurality of members 12 each having a length (L). The plurality of members 12 may have a uniform length (L), or the length (L) may vary among the plurality of members 12. As illustrated, a first member 12A is connected to a second member 12B via an integrated connector 14. The connector 14 includes a receiving portion 16 and an engaging portion 18. The first member 12A includes the receiving portion 16 while the second member 12B includes the engaging portion 18 so that the first member 12A may be connected to the second member 12B. It should be noted that the members 12 may be connected during a co-extrusion, a co-pultrusion, or both of the structural assembly 10 such that manufacturing of the structural assembly 10 may be free of a secondary operation to connect the members 12. As illustrated in FIGS. 1A and 1B, the structural assembly 10 may have various connector 14 configurations. For example, in FIG. 1A the connector 14 may include a receiving portion 16 with one or more projections configured to receive a hook-shaped engaging portion 18. Alternatively, or additionally, as shown in FIG. 1B, the connector 14 may include a receiving portion 16 configured to receive a dovetail-shaped engaging portion 18.

FIGS. 2A and 2B illustrate a structural assembly 10. The structural assembly 10 includes a plurality of members 12. As illustrated, a first member 12A is connected to a second member 12B via an integrated connector 14. The connector 14 includes a plurality of receiving portions 16 and a plurality of engaging portions 18. The first member 12A includes the receiving portions 16 while the second member 12B includes the engaging portions 18 so that the first member 12A may be connected to the second member 12B. It should be noted that the members 12 may be connected during a co-extrusion, a co-pultrusion, or both of the structural assembly 10 such that manufacturing of the structural assembly 10 may be free of a secondary operation to connect the members 12. Additionally, as shown in FIG. 2B, the structural assembly 10 may include an adhesive material 20 disposed on one or more surfaces.

FIG. 3 illustrates a structural assembly 10. The structural assembly 10 includes a plurality of members 12. As illustrated, a first member 12A is connected to a second member 12B via an integrated connector 14. The connector 14 includes a plurality of receiving portions 16 and a plurality of engaging portions 18. The first member 12A includes the receiving portions 16 while the second member 12B includes the engaging portions 18 so that the first member 12A may be connected to the second member 12B. It should be noted that the members 12 may be connected during a co-extrusion, a co-pultrusion, or both of the structural assembly 10 such that manufacturing of the structural assembly 10 may be free of a secondary operation to connect the members 12. Both members 12 include one or more ribs 22 projecting from one or more surfaces. Additionally, an adhesive material 20 is disposed on one or more surfaces of the members 12.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of within a range of 100+/−15.

### ELEMENT LIST

10 Structural Assembly

12 Member

12A First Member

12B Second Member

14 Connector

16 Receiving Portion

18 Engaging Portion

20 Adhesive Material

22 Rib

24 Bend

L Length (of the Member)

What is claimed is:

1. A structural assembly comprising: a plurality of members connected via one or more connectors, wherein the one or more connectors are integrally formed with the plurality of members and the plurality of members are connected via the one or more connectors during extrusion of the plurality of members.

2. The structural assembly according to claim 1, wherein the plurality of members are co-extruded.

3. The structural assembly according to claim 1, wherein a first member includes a receiving portion and a second member includes an engaging portion, and the receiving portion receives the engaging portion during extrusion to form the connector.

4. The structural assembly according to claim 1, wherein a surface of each of the plurality of members is coplanar, and the one or more connectors project from the surface of the each of the plurality of members.

5. The structural assembly according to claim 1, wherein an exterior surface of each of the plurality of members is coplanar, and the one or more connectors are recessed or extend substantially perpendicular to the exterior surface of each of the plurality of members.

6. The structural assembly according to claim 1, wherein the plurality of members include one or more ribs.

7. The structural assembly according to claim 1, wherein the structural assembly has a length greater than 200 mm.

8. The structural assembly according to claim 1, wherein the plurality of members include an adhesive material disposed on one or more surfaces.

9. The structural assembly according to claim 1, wherein the connector includes an adhesive material disposed on one or more surfaces.

10. The structural assembly according to claim 1, wherein the one or more connectors is a dovetail joint.

11. The structural assembly according to claim 1, wherein the one or more connectors include an engaging portion having one or more fingers that are received by a receiving portion having one or more channels.

12. The structural assembly according to claim 8, wherein the adhesive material is an expandable material.

13. The structural assembly according to claim 11, wherein the one or more fingers are a plurality of fingers that are each received by a separate channel.

14. The structural assembly according to claim 6, wherein the one or more ribs are a plurality of ribs, and the one or more ribs have a non-uniform height and are configured to compress during an impact.

15. The structural assembly according to claim 1, wherein the one or more connectors are only disconnected after extrusion via inelastic deformation.

16. The structural assembly according to claim 1, wherein each of the plurality of members includes a receiving portion, an engaging portion, or both.

17. The structural assembly according to claim 1, wherein the plurality of members are substantially equal in length.

18. The structural assembly according to claim 16, wherein the receiving portion encloses the engaging portion.

19. The structural assembly according to claim 6, wherein the one or more ribs elastically deform during activation of an expandable adhesive material disposed on the plurality of members, and the one or more ribs include one or more bends to deflect the expandable adhesive material in a desired direction.

20. A method of forming a structural assembly according to claim 1 comprising: co-extruding a plurality of members, wherein the plurality of members are connected via one or more integrally formed connectors, and the connection occurs during the co-extrusion process.
